(19) United States
(12) Patent Application Publication
(10) Pub. No.: US 2019/0133354 A1
(43) Pub. Date: May 9, 2019

(54) DIETARY PORTION CONTROL DRINKWARE

(71) Applicant: Samantha Tighiouart, Altamonte Springs, FL (US)

(72) Inventor: Samantha Tighiouart, Altamonte Springs, FL (US)

(21) Appl. No.: 15/802,758

(22) Filed: Nov. 3, 2017

(51) Int. Cl. A47G 19/22; G01F 25/00; G01F 19/00

(52) U.S. Cl. CPC A47G 19/2227; G01F 19/00; G01F 25/0061

(57) ABSTRACT

A drink vessel or glass (1A, 1B, 1C, 1D, 1E, 1F, 1G) with liquid level marks (5A, 5B, 6A, 6B). Each level is labeled (7, 8, 12) with the name or symbol of a respective liquid, and is also labeled (9, 10, 14) with the volume. A third level (11B) may be marked near the rim (4B) or may be limited by the rim. For example, a drink vessel for adults (1B) may have a 12 or 16 ounce maximum capacity with level marks at 4 fluid ounces for juice; at 8 ounces for milk; and a mark or upper limit at the rim of 12 or 16 ounces for water. A child's glass (1A) may have an 8 ounce maximum capacity with level marks at 4 ounces for juice and at 8 ounces for milk.

### FIELD

The invention relates to drinkware designed to serve measured portions of named liquids that are labeled on the drinkware at respectively marked liquid levels.

### BACKGROUND

A person's perception of a drink size is influenced by the size of the drinkware used. Large glasses and cups can train people to drink too much of some liquids, especially sugary liquids, including fruit juices. Lack of portion guidance causes people to drink too much of some liquids, and not enough of others.

### DRAWINGS

FIG. 1 is a front view of a child's drink vessel in accordance with aspects of the invention. The back view may be the same.

FIG. 2 is a left side view of the drink vessel of FIG. 1. The right side view may be the same or it may be marked with equivalent indicia in another unit of measure.

FIG. 3 is a front view of an adult drink vessel in accordance with aspects of the invention. The back view may be the same.

FIG. 4 is a left side view of the drink vessel of FIG. 3. The right side view may be the same, or it may be marked with equivalent indicia in another unit of measure.

FIG. 5 is a front sectional view of a drinkware stacking arrangement with a child's drink vessel nested inside an adult drink vessel for compact shipping and storage.

FIG. 6 is a front sectional view of a drinkware stacking arrangement with a child's drink vessel nested inside an adult drink vessel which is nested inside another adult drink vessel of the same size.

FIG. 7 is a front sectional view of a drinkware stacking arrangement with a child's drink vessel nested inside an adult drink vessel which is nested inside a larger adult drink vessel.

FIG. 8 is a front sectional view of a cylindrical drinkware stacking arrangement with a child's drink vessel nested inside an adult drink vessel which is nested inside a larger adult drink vessel.

FIG. 9 shows an insert card for the drinkware listing the number of servings of each liquid prescribed or recommended by a doctor or nutritionist.

### DETAILED DESCRIPTION

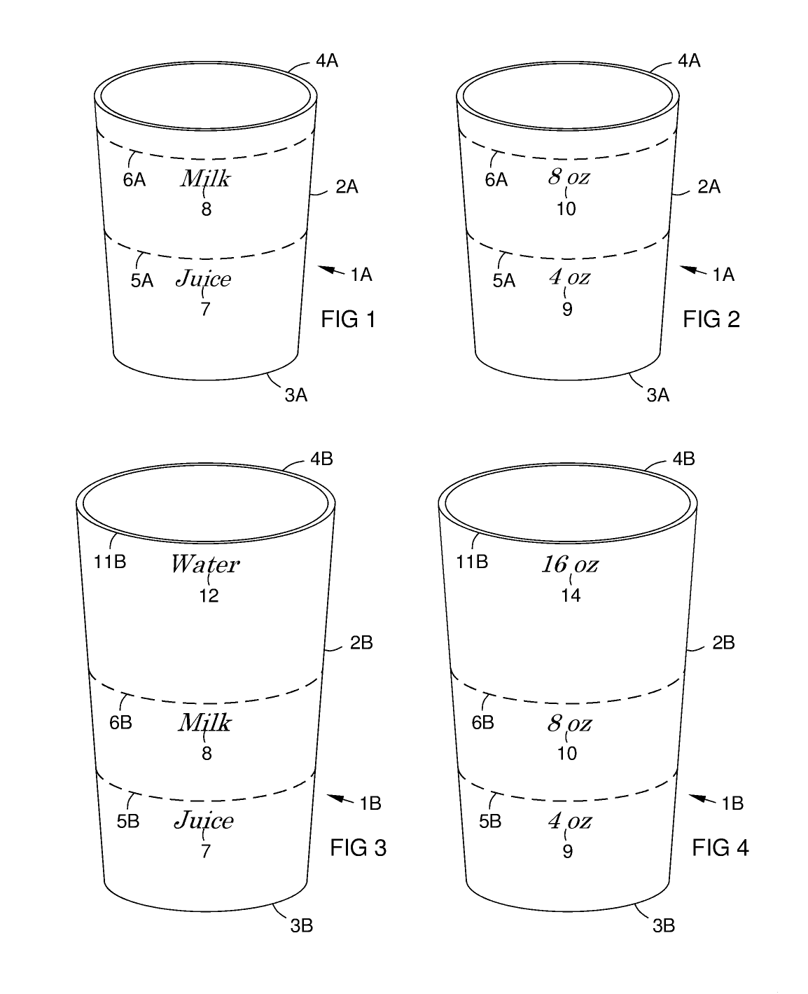

FIG. 1 is a front view of a drink vessel 1A for children. It has an encircling wall 2A with a closed bottom 3A and an open top rim 4A. First and second liquid level marks 5A, 6A encircle the wall 2A, and are visible from all sides of the vessel. Each level mark 5A, 6A may be a line or a dashed line that encircles the wall in a respective horizontal plane. Each level mark is labeled 7, 8 with the name and/or symbol of a liquid to be filled from the bottom 3A to the level mark. The level marks provide recommended volumes of each named liquid. The wall 2A may be transparent or translucent, so the liquid can be seen. It may be made for example of glass or plastic, such as such as Tritan™ copolyester. The back view of the vessel may be the same as the front view, with the liquid names labeled the same way. Optionally, for decorative purposes, clear or translucent windows may be provided in an otherwise opaque or darker colored wall 4A, or a decorative pattern of clear and opaque or darker colored areas may be provided.

The named liquids may be represented by text and/or symbols. As non-limiting examples, milk may be represented by a cow icon; juice may be represented by a fruit icon; and water may be represented by a blue wave or spigot icon or “H₂O”.

FIG. 2 is a side view of the vessel 1A. Here each of the level marks 5A, 6A is labeled with the volume of the vessel from the bottom 3A to the mark. For example, the juice line 5A indicates with label 9 the level of 4 fluid ounces, and the milk line 8A indicates with label 10 the level of 8 fluid ounces. This follows current dietary guidelines for fruit juice and milk. The levels may be labeled in fluid ounces and/or in cups and/or in metric equivalent units such as milliliters. The term “metric equivalent” includes a metric conversion with optional rounding. In one embodiment it includes a metric conversion plus or minus up to 2% for rounding. This allows for example a 4 oz metric equivalent to be labeled as 118.3 ml, 118 ml, or 120 ml. Optionally, multiple equivalent units of measure may be shown on the vessel, for example with US or imperial units on one side and metric equivalent units on the opposite side or with both units on both sides.

FIG. 3 is a front view of a drink vessel 1B for adults. It may have a frustroconical wall 2B as shown with a closed bottom 3B of smaller diameter than the open top rim 4B, or it may be cylindrical or other shapes. First and second liquid level marks 5B, 6B are provided around the wall 2B, and are visible from all sides of the vessel. For example, each level mark may be a line or a dashed line that encircles the wall in a respective horizontal plane. A third level mark 11B may be provided at or near the rim 4B, or the rim itself may provide the third level. Each level is labeled 7, 8, 12 with the name and/or symbol of a liquid to be filled from the bottom 3B to the indicated level to provide a recommended volume of each named liquid. The wall 2B may be transparent or translucent, so the liquid can be seen. Alternately, windows may be provided in an otherwise opaque wall, or a decorative pattern of opaque and clear areas may be provided. The back view of the vessel may be the same as the front view, with the liquid names labeled the same way.

FIG. 4 is a side view of the vessel 1B. Here each of the level marks 5B, 6B, and the level mark 11B or the rim 4B is labeled with the volume of the vessel from the bottom 3B to the mark or rim. For example, the juice line 5B indicates with label 9 the level of 4 fluid ounces, the milk line 8B indicates with label 10 the level of 8 US fluid ounces, and the water line 11B indicates with label 14 the level of 16 fluid ounces. On an adult drink vessel, the water level may be between 1.5 and 2 times the milk level. For example, the milk level may be 8 ounces and the water level may be 12 ounces. The level lines may be labeled in fluid ounces and/or cups and/or equivalent metric units such as milliliters. Optionally, multiple equivalent units of measure may be shown on the same vessel, for example with US or imperial units on one side, and metric equivalent units on the opposite side or with both units on both sides.

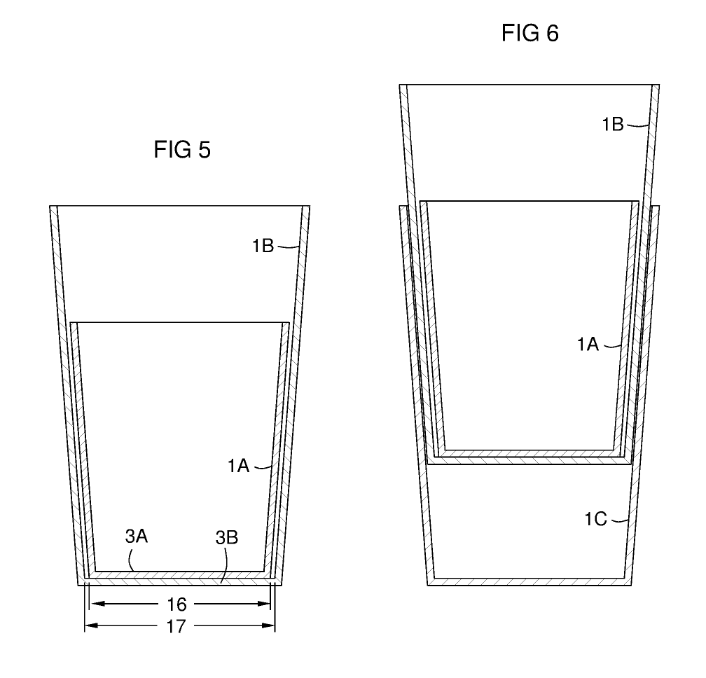

FIG. 5 shows a child's vessel 1A sized to nest inside an adult vessel 1B for compact shipping and storage. The child and adult vessels 1A, 1B may be frustroconical as shown. If so, the child's vessel 1A will tend to bind in the adult vessel if the two vessels have the same bottom diameter. Therefore, the child's vessel 1A should be of smaller diameter than the adult vessel, including a bottom outer diameter 16 that is smaller than the interior diameter 17 of the bottom 3B of the adult vessel 1B. This difference in vessel diameters results in the liquid level lines for the child's version being located higher from the bottom of the child vessel than the corresponding level lines of the adult version. The correct position for each level line may be determined with Computer Aided Design software, and checked by pouring a liquid into each vessel 1A, 1B from an accurate measuring cup.

FIG. 6 shows a further frustroconical stacking of a child's drink vessel 1A inside an adult vessel 1B, which is in turn nested in another adult vessel 1C. If the adult vessels 1B and 1C are the same size, they will partially nest as shown. Vessel 1B may bind in vessel 1C. However, vessel 1B extends above the vessel 1C, making it easy to grip both vessels to separate them.

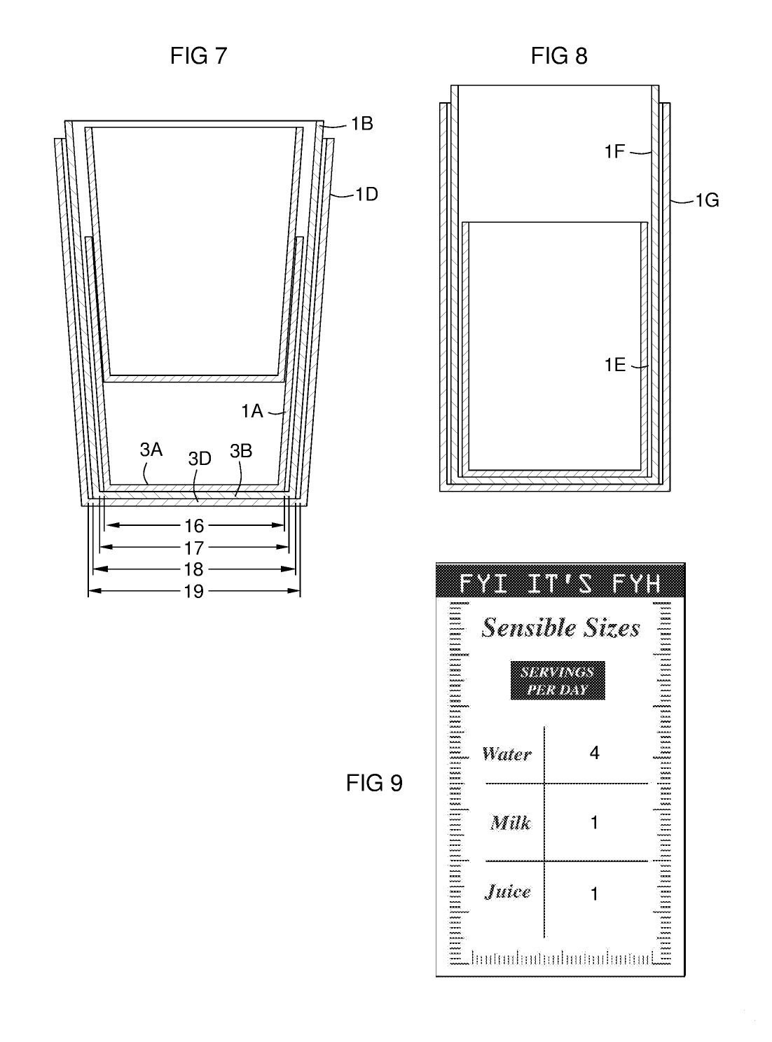

FIG. 7 shows a another frustroconical stacking arrangement with two child's drink vessels 1A nested inside an adult drink vessel 1B which is in turn nested inside a larger adult drink vessel 1D. This arrangement provides three nested vessels for compact shipping and storage. The child's vessel 1A has a smaller diameter than the adult vessel 1B, including a bottom outer diameter 16 that is smaller than the interior diameter 17 of the bottom 3B of the adult vessel 1B. The inner adult vessel 1B in turn has a smaller diameter than the outer adult vessel 1D, including a bottom outer diameter 18 that is smaller than the interior diameter 19 of the bottom 3D of the outer adult vessel 1D. This difference in vessel diameters avoids binding of the nested vessels. This difference also results in the level lines for the child's version being located higher from the bottom of the child vessel 1A than the corresponding liquid level lines of the adult vessel 1B. The same is true for the level lines of the inner adult vessel 1A relative to the outer adult vessel 1D. The correct position of each level line may be determined with Computer Aided Design software, and checked by pouring a liquid into each vessel 1A, 1B, 1D from an accurate measuring cup.

Optionally, different drink vessels of a set may provide different levels for different users. For example, a child's vessel 1A may provide 4 and 8 oz levels labeled “Juice” and “Milk” respectively, while a larger diameter adult vessel 1B may provide 3, 6, and 14 oz levels labeled “Juice”, “Milk”, and “Water” respectively, and a still larger diameter adult vessel 1D may provide 4, 6, and 16 oz levels labeled “Juice”, “Milk” and “Water” respectively. Providing different levels gives options for portion control guidance for people with different nutrition level requirements. In a set of drink vessels according to aspects of the invention with this option, at least one drink vessel may provide at least one liquid level indicator that differs at least 10% from a corresponding one of the liquid level indicators of at least one other of the drink vessels.

FIG. 8 shows a cylindrical stacking arrangement with a child's drinking vessel 1E within an adult drinking vessel 1F, which is within a larger adult drinking vessel 1G. This arrangement has the characteristics and options of the frustroconical arrangement of FIG. 7 except for the cylindrical shape of the vessels.

FIG. 9 shows an insert card for the drinkware listing a number of servings of each liquid to be written by a doctor or nutritionist. Several such cards may be provided in each package of drinkware. The shown number of servings is for example only.

Sets of the drink vessels herein may be provided in glass or plastic, for example a copolyester such as Tritan™. The drinkware herein provides measurements for healthy portions and healthy proportions of different named liquids. This results in cognitive behavior guidance that some researchers suggests can help rewire the brain. In rewiring the brain you alter the hormone and enzyme output that lead to overeating and obesity.

The drinkware herein can assist in therapeutically aiding those with lower literacy, improve communication between provider and patient, and assist both adults and children in making better choices for self-health care management. Commonly, 80% of patients forget what a healthcare provider said, and 50% recall incorrect information. The drinkware along with the insert reduces communication and memory errors.

The visual aspects of the drinkware manipulate patient perception on a cognitive level, creating an optical illusion of fullness in the glass, thus modifying behavior in a positive manner leading to lifestyle changes. It functions as a communication tool by teaching proper portion control, taking the guesswork out of portion size, empowering the patient with knowledge, improving therapeutic communication with provider. All of which, when used properly, serve to reduce obesity, improve glucose levels, and increase patient participation in self-managed care which can reduce the risk of comorbid diseases. This reduction in preventable chronic diseases can drive down health care costs.

The glass serves as a communication tool, therapeutic tool (brain rewiring and weight loss) as well as educational tool (empowerment with self-managed care/portion size). While weight loss and reduction of chronic disease may be an effect, there is also functionality of the drinkware in itself. This drinkware is designed to show, teach, and change perception of what and how much product one should go in drinkware.

While various embodiments of the present invention have been shown and described herein, such embodiments are provided by way of example only. Variations, changes and substitutions may be made without departing from the invention herein.

The invention claimed is:

1. A drink vessel with a top rim and a closed bottom comprising:
a surrounding wall forming sides of the vessel;
first and second liquid level marks encircling the wall;
a first label on the wall proximate the first liquid level mark indicating a name or symbol of a first liquid;
a second label on the wall proximate the first liquid level mark indicating a first volume of the vessel from the bottom thereof to the first liquid level mark;
a third label on the wall proximate the second liquid level mark indicating a name or symbol of a second liquid; and
a fourth label on the wall proximate the second liquid level mark indicating a second volume of the vessel from the bottom thereof to the second liquid level mark; and

2. The drink vessel of claim 1 wherein the second volume is twice the first volume.

3. The drink vessel of claim 1 wherein:
the first volume is 4 fluid ounces;
the first label comprises “Juice” or a symbol for juice;
the second label indicates “4 ounces” or an equivalent in another unit of measure;
the second volume is 8 fluid ounces;
the third label comprises “Milk” or a symbol for milk; and
the fourth label indicates “8 ounces” or an equivalent in another unit of measure.

4. The drink vessel of claim 1 further comprising:
a fifth label on the vessel wall proximate the top rim indicating a name or symbol of a third liquid; and
a sixth label on the wall proximate the top rim indicating a third volume of the vessel from the bottom of the vessel to the top rim thereof.

5. The drink vessel of claim 4 wherein the third volume is 1.5-2 times the second volume.

6. The drink vessel of claim 4 wherein:
the first volume is 4 fluid ounces;
the first label comprises “Juice” or a symbol for juice;
the second label indicates “4 ounces” or an equivalent in another unit of measure;
the second volume is 8 fluid ounces;
the third label comprises “Milk” or a symbol for milk;
the fourth label indicates “8 ounces” or an equivalent in another unit of measure;
the third volume is 12 or 16 fluid ounces;
the fifth label comprises “Water” or a symbol for water; and
the sixth label indicates “12 ounces” or “16 ounces” or a respective equivalent in another unit of measure.

7. The drink vessel of claim 6 wherein:
each of the liquid level marks comprises a line or a dashed line encircling the wall in a respective horizontal plane;
the first, third, and fifth labels are marked on both a front side and a back side of the vessel; and
the second, fourth, and sixth labels are marked on both a left side and a right side of the vessel; and further comprising
an instruction card listing a recommended or prescribed number of servings per day for each of the first, second, and third liquids.

8. The drink vessel of claim 1 further comprising:
a third liquid level mark around the wall of the vessel above the second liquid level line;
a fifth label on the vessel wall proximate the third liquid level mark indicating a name or symbol of a third liquid; and
a sixth label on the wall proximate the third liquid level mark indicating a third volume of the vessel from the bottom of the vessel to the third liquid level mark.

9. First and second drink vessels in accordance with claim 2, wherein the second vessel further comprises:
a fifth label on the vessel wall proximate the rim indicating a name or symbol of a third liquid; and
a sixth label on the wall proximate the rim indicating a third volume of the vessel from the bottom of the vessel to the rim thereof;
wherein the first drink vessel nests within and sits on the bottom of the second drink vessel without binding therein.

10. A first drink vessel comprising:
a wall around an interior volume of the vessel, the wall forming sides of the vessel, wherein the wall is at least partly transparent or translucent;
first and second level marks around the wall, visible from all sides of the vessel, that correspond to respective first and second liquid levels in the vessel;
the first level mark labeled on a front side of the vessel with a name or symbol of a first liquid;
the second level mark labeled on the front side of the vessel with a name or symbol of a second liquid;
a first volume label on the wall proximate the first level mark indicating a first volume of the vessel from a bottom of the vessel to the first liquid level mark; and
a second volume label on the wall proximate the second level mark of the vessel indicating a second volume of the vessel from the bottom of the vessel to the second liquid level mark.

11. The first drink vessel of claim 10 wherein the name of the first liquid is “Juice” and the name of second liquid is “Milk”.

12. A set of drink vessels including the first drink vessel of claim 11, the set of drink vessels further comprising:
a second drink vessel also in accordance with claim 11, wherein the second drink vessel has an inner diameter larger than an outer diameter of the first drink vessel, wherein the first drink vessel sits on the bottom of the second drink vessel without binding therein;
a third drink vessel also in accordance with claim 11, wherein the third drink vessel has an inner diameter larger than an outer diameter of the second drink vessel, wherein the second drink vessel sits on the bottom of the third drink vessel without binding therein;
wherein at least the third drink vessel comprises a third liquid level at or proximate a top rim of the vessel with a label of “Water” or a symbol for water.

13. The set of vessels of claim 12, wherein the second liquid level is twice the first liquid level.

14. The set of vessels of claim 12, wherein for at least one of the first, second, and third drink vessels, at least one of the liquid levels differs at least 10% from a corresponding one of the liquid levels of at least one other of the drink vessels.

15. The first drink vessel of claim 10 further comprising:
the first level labeled on both a front side and a back side of the vessel with the name or symbol of the first liquid;
the second level labeled on both the front and back sides of the vessel with the name or symbol of the second liquid;
the first volume label repeated on a left and a right side of the vessel; and
the second volume label repeated on the left and right sides of the vessel.

16. The first drink vessel of claim 15 wherein:
the first liquid level is 4 fluid ounces, the name of the first liquid is “Juice”, and the first volume label indicates “4 oz” or a metric conversion from 4 fluid ounces plus or minus up to 2%; and
the second liquid level is 8 fluid ounces, the name of the second liquid is “Milk”, and the second volume label indicates “8 oz” or a metric conversion from 8 fluid ounces plus or minus up to 2%.

17. The first drink vessel of claim 16 wherein the first and second level marks comprises respective first and second dashed lines encircling the wall.

18. The first drink vessel of claim 17, further comprising:
a third liquid level of 12 or 16 fluid ounces at or proximate a top rim of the vessel with a label of “Water” or a symbol for water; and
a third volume label proximate the top rim of the vessel on the left and right sides of the vessel indicating “12 oz” or “16 oz” or a metric conversion from 12 or 16 fluid ounces respectively plus or minus up to 2%.

19. The first drink vessel of claim 18 wherein the wall is frustroconical with a closed bottom of relatively smaller diameter than an open top thereof, and further comprising a second drink vessel also in accordance with claim 15, wherein the second drink vessel is frustroconical with a closed bottom having an outer diameter smaller than an inner diameter of the closed bottom of the first drink vessel, wherein the second drink vessel sits on the bottom of the first drink vessel without binding therein.

20. A set of drinkware comprising:
first and second drink vessels, the first drink vessel nesting within the second drink vessel;
wherein each of the drink vessels comprises at least two liquid level indicators, each said indicator annotated with a liquid volume from a bottom of the drink vessel to the level indicator and further annotated with the name or symbol of a respective liquid; and
the first drink vessel has a liquid level indicator that differs by at least 10% in volume from a corresponding liquid level indicator with the same annotated liquid name or symbol in the second drink vessel.
